(19) United States
(12) Patent Application Publication
(10) Pub. No.: US 2008/0277210 A1
(43) Pub. Date: Nov. 13, 2008

(54) VEHICLE BRAKING SYSTEM

(75) Inventors: Ryuta Inoue, Shizuoka-ken (JP); Seiji Nakagaki, Shizuoka-ken (JP); Takeshi Ito, Shizuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignee: YAMAHA HATSUDOKI KABUSHIKI KAISHA, Shizuoka-ken (JP)

(21) Appl. No.: 12/118,162

(22) Filed: May 9, 2008

(30) Foreign Application Priority Data
May 10, 2007 (JP) 2007125522

(51) Int. Cl. B60T 1/06

(52) U.S. Cl. 188/17

(57) ABSTRACT

A vehicle braking system that includes an interior space for accommodating a plurality of rotational friction plates and a plurality of fixed friction plates. The interior spaced is formed by a brake housing and a wheel hub, and lubrication oil for lubricating the plurality of rotational friction plates and the plurality of fixed friction plates is contained within the interior space. The brake housing includes a projection, or projection portion, which projects closer to center of an axle, along a longitudinal axis of the axle, than innermost surfaces of the rear wheels. In one arrangement, the projecting portion is located below the axle. In addition, one or more cooling fins can be provided on a surface of the projecting portion. Furthermore, in some arrangements, a space within the projecting portion projects closer to center of an axle, along a longitudinal axis of the axle, than innermost surfaces of the rear wheels.

### RELATED APPLICATIONS

This application is related to, and claims the benefit of, Japanese Patent Application No. 2007-125522, filed May 10, 2007, the entirety of which is hereby incorporated by reference herein and made a part of the present specification.

### BACKGROUND OF THE INVENTION

1. Field of the Invention

The present invention relates to a vehicle braking system provided with a space for retaining lubrication oil for lubricating a plurality of rotational friction plates and a plurality of fixed friction plates that form a portion of the braking system.

2. Description of the Related Art

Conventionally, a vehicle is provided with a braking system, and a running vehicle can be slowed or brought to a stop by operation of the braking system. One such braking system includes a plurality of rotational friction plates and a plurality of fixed friction plates. Lubrication oil is provided for lubricating the plurality of rotational friction plates and fixed friction plates for sliding movement within the braking system. One example of such a braking system is disclosed in U.S. Pat. No. 4,890,699 to Megginson et al. In this braking system, an oil chamber, in which the rotational friction plates and the fixed friction plates are disposed, includes a pair of end plates positioned on opposing ends of the collection of rotational and fixed friction plates. A cylindrical cover plate is disposed on an outer periphery of the collection of rotational and fixed friction plates between the pair of end plates. A cylindrical support member is positioned within an inner periphery of the collection of rotational and fixed friction plates between the pair of end plates. In addition, there is a known braking system formed with a cooling fin in a brake housing that defines the oil chamber. For example, such an arrangement is disclosed in U.S. Pat. No. 6,516,924 to Michael et al.

### SUMMARY OF THE INVENTION

However, certain disadvantages are present in an arrangement such as that disclosed in the Megginson et al. reference, in which a pair of end plates, a cover plate, and a support member define an oil chamber of a braking system, and a brake housing of a braking system such as that disclosed in the Michael et al. reference, in which the brake housing is disposed in a space defined within a rim member on an inboard side of a wheel assembly, which includes the rim member and a tire mounted on the rim member. Therefore, when a vehicle equipped with a brake assembly such as those described above is in operation, it becomes difficult to deliver a flow of air to the oil chamber and the brake housing as the air is blocked by the wheel. As a result, the cooling effect on the oil chamber and the brake housing by the flow of air may be insufficient.

One or more preferred embodiments of the present invention address the foregoing problem. Therefore, it is an object of one or more embodiments to provide a vehicle braking system that can effectively cool off lubrication oil for lubricating the plurality of rotational friction plates and the plurality of fixed friction plates utilized in the braking system.

In order to address the aforementioned object, a vehicle braking system according to one embodiment includes a plurality of annular rotational friction plates engaged with a wheel hub. The wheel hub is fixed to the periphery of an end of an axle for rotation with the axle. The rotational friction plates are capable of relative movement in an axial direction (along the longitudinal axis of the axle) with respect to the wheel hub and are capable of being fixed for rotation with the wheel hub. A plurality of annular fixed friction plates, each of which are disposed between a pair of the plurality of rotational friction plates. A peripheral portion of each of the fixed friction plates is engaged with an inner periphery of a cylindrical engagement section of a brake housing, which is fixed to an axle support member for supporting the axle. The fixed friction plates are capable of movement in the axial direction relative to the brake housing and are rotationally fixed relative to the brake housing. Rotation of the axle is restrained by pressing the plurality of rotational friction plates and the plurality of fixed friction plates against one another in the axial direction. The brake housing and the wheel hub cooperate to form a space for accommodating the plurality of rotational friction plates and the plurality of fixed friction plates. A lubricant, such as a lubricating oil, is provided within the space for lubricating the plurality of rotational friction plates and the plurality of fixed friction plates. A portion of the brake housing that is located below the axle projects beyond an inner side of a wheel, which is supported by the axle, toward a center portion of the axle along a longitudinal axis of the axle.

A vehicle braking system according to an embodiment as described above retains the lubrication oil in the space for accommodating the plurality of rotational friction plates and the rotational fixed friction plates formed by the brake housing and the wheel hub. Further, a portion of the brake housing that forms the space is projected closer to an inner side of a vehicle than the end of the inner side of the wheel that is supported by the axle. Accordingly, the brake housing is not blocked by the wheel and, thus, the brake housing is exposed to a flow of air when the vehicle is moving.

As a result, the lubrication oil, or other lubricant, inside the brake housing is effectively cooled. In addition, because the portion of the brake housing projected closer to the inner side of the vehicle than the end of the inner side of the wheel is located below the axle, the lubrication oil is effectively cooled and, in addition, the lubrication oil tends to move to the lower portion of the space due to the gravity. Furthermore, because only a portion of the brake housing is projected inward from the inner side of the wheel, a cooling effect of the lubrication oil can be enhanced without enlarging the entire brake housing.

In addition, another structural characteristic of the vehicle braking system according to an embodiment is that one or more cooling fins are provided in a portion of the brake housing which projects closer to the center of the axle than the end of the inner side of the wheel. As described above, the cooling effect of the lubrication oil can be further enhanced by providing the cooling fin(s) in the projecting portion of the brake housing.

Moreover, yet another structural characteristic of the vehicle braking system according to an embodiment is that a part of the space in the brake housing is located below the axle and closer to the center of the axle than the end of the inner side of the wheel. With such an arrangement, a cooling efficiency of the lubrication oil can be enhanced while also allowing the portion for retaining the lubrication oil in the brake housing to provide a sufficient volume for the lubrication oil.

### BRIEF DESCRIPTION OF THE DRAWINGS

These and other features, aspects and advantages of the present vehicle braking system are described below with reference to preferred embodiments, which are intended to illustrate and not to limit the present invention. The drawings contain seven (7) figures.

FIG. 1 is a side view of a golf cart incorporating a vehicle braking system in accordance with an embodiment of the present invention.

FIG. 2 is a side view of a portion of the braking system inside the golf cart. Portions of the golf cart are illustrated in dashed lines for the purpose of clarity.

FIG. 3 is a plan view of the golf cart shown in FIG. 2, with the body and certain other components removed. An outline of each of the tires is illustrated by a dashed line.

FIG. 4 is a cross-sectional of the vehicle braking systems provided on each side of a rear axle as viewed from the front of the golf cart.

FIG. 5 is a sectional view of the vehicle braking system of FIG. 4 provided in a rear wheel connected to the left side of the rear axle.

FIG. 6 is a sectional view of the vehicle braking system.

FIG. 7 is a side view showing a coupling part of a brake wire and the vehicle braking system.

### DETAILED DESCRIPTION OF THE PREFERRED EMBODIMENTS

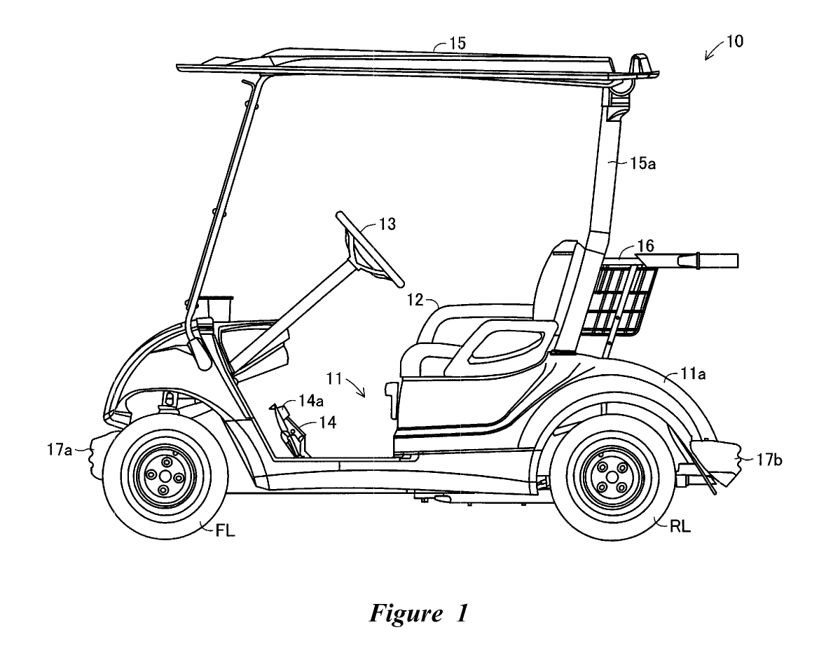

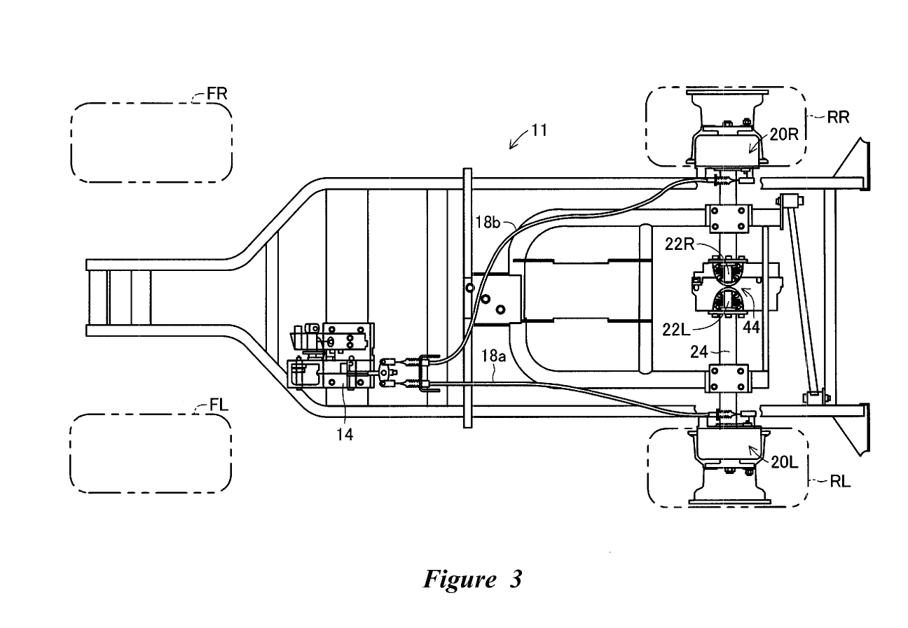

A description is hereinafter made of a vehicle braking system according to an embodiment of the present invention with reference to the drawings. FIG. 1 shows a wheeled vehicle, such as a golf cart 10, having a vehicle braking system according to the embodiment of the present invention. This golf cart 10 is provided with four wheels, which includes front wheels FL, FR provided on both left and right sides of a front section at the bottom of a vehicle body 11 (see FIG. 3) and rear wheels RL, RR provided on both left and right sides of the rear section at the bottom of the vehicle body 11 (see FIG. 3). A seat 12 is provided slightly toward a rear side of the center of the vehicle body 11 in a lengthwise direction. A steering wheel 13 is provided in front of the seat 12, and an accelerator pedal (not shown) and a brake pedal 14 are provided side by side below the steering wheel 13. In addition, a roof 15 is provided above the vehicle body 11 via a support frame 15a.

A baggage placement member 16 for placing golf club bags is attached over a cowl 11a, which configures a rear section of the vehicle body 11. A front bumper 17a is attached to a front bottom of the vehicle body 11, and a rear bumper 17b is attached to a rear bottom of the cowl 11a. The golf cart 10 changes the direction of the front wheels FL, FR to the left or right when a driver sitting on the seat 12 performs a turning operation of the steering wheel 13, and consequently changes a traveling direction by turning left or by turning right.

Also, the golf cart 10 is accelerated in accordance with a position of the accelerator pedal when the driver presses the accelerator pedal. When the driver presses the brake pedal 14, rotary drive of the rear wheels RL, RR is slowed or brought to a stop in accordance with an amount the brake pedal 14 is pressed. A parking pedal 14a is provided on one side in the horizontal direction at a top end of the brake pedal 14. If the parking pedal 14a is pressed while the brake pedal 14 being pressed, the brake pedal 14 is locked for retaining the braking system in an engaged position.

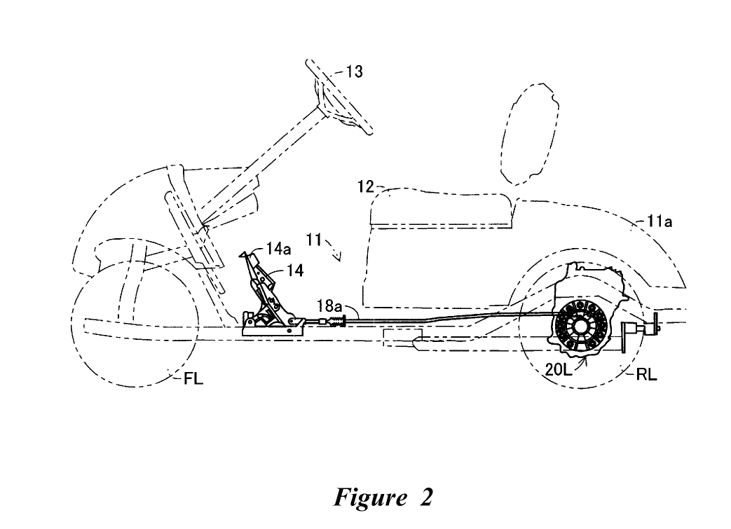

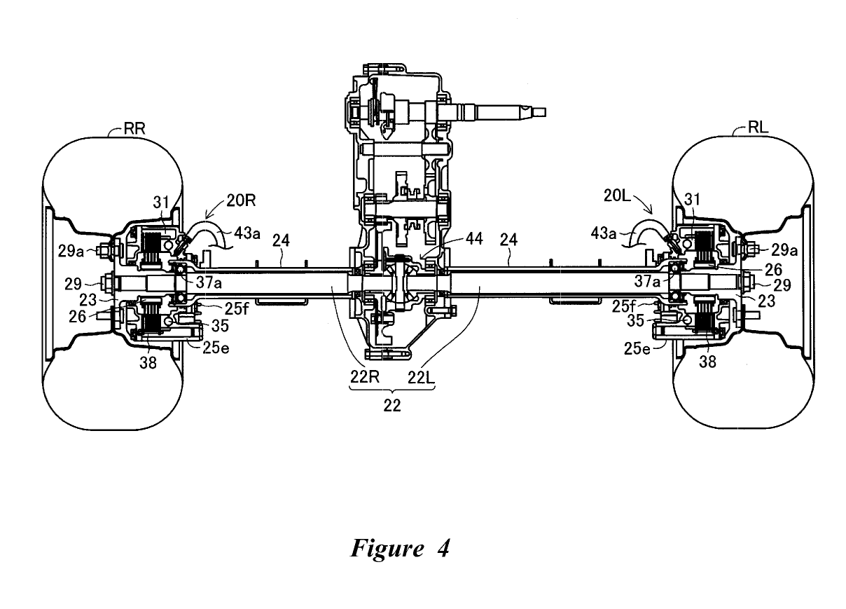

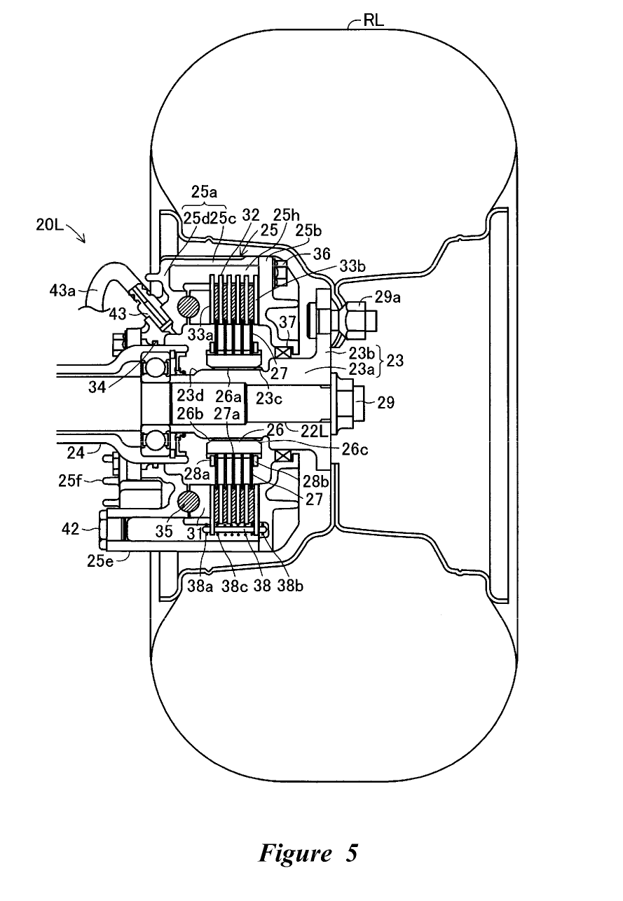

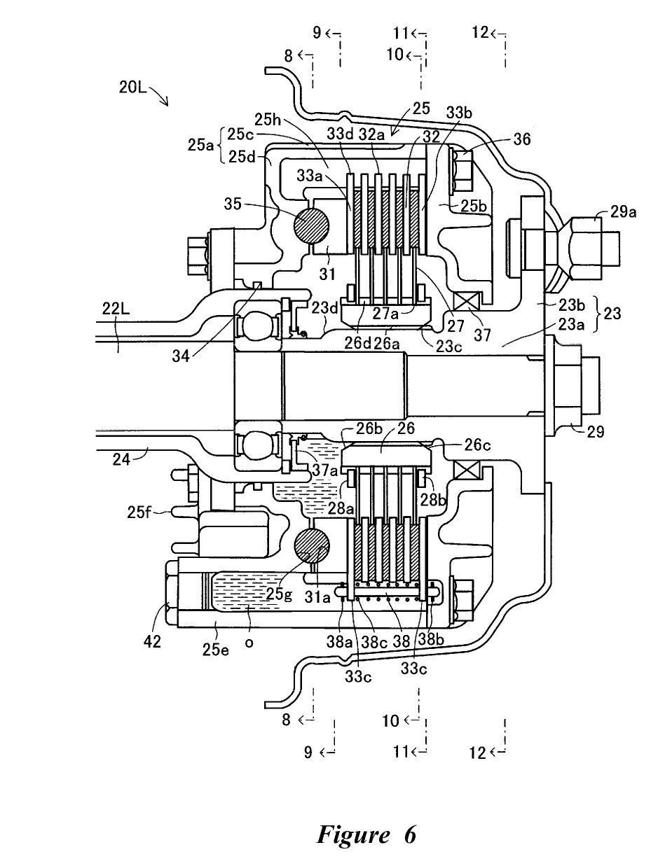

As shown in FIG. 2 and FIG. 3 (viewing the vehicle body 11 from above), the brake pedal 14 is coupled to vehicle braking systems 20L, 20R provided respectively on the rear wheels RL, RR via a pair of brake lines, or brake wires 18a, 18b. The vehicle braking systems 20L, 20R, as shown in FIG. 4 (viewing the vehicle body 11 from the front), are configured with generally same constructions disposed symmetrically. In addition, FIG. 5 shows the vehicle braking system 20L provided on the rear wheel RL, and FIG. 6 is an enlarged view of the vehicle braking system 20L in FIG. 5.

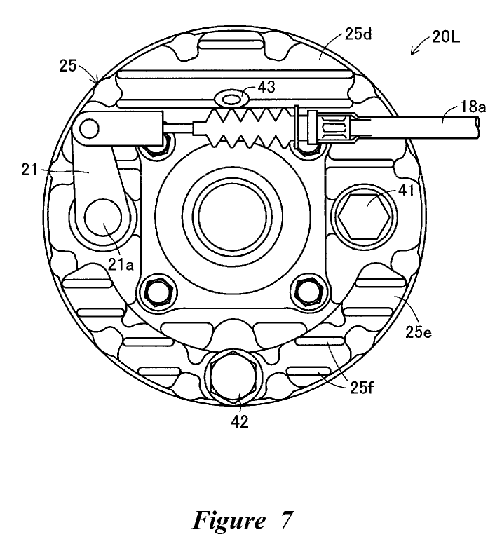

The vehicle braking system 20L is coupled with the brake wire 18a via a lever member 21 shown in FIG. 7, and a biasing member, such as a torsion spring (not shown), for urging the brake wire 18a rearward (to the left in the orientation shown in FIG. 7) acts on the lever member 21. An axle assembly 22 is formed with an axle 22L coupled with the rear wheel RL and an axle 22R coupled with the rear wheel RR. The vehicle braking system 20L includes a rotational portion formed with parts such as a wheel hub 23 attached to the left end of the axle 22L (left side viewing from the driver sitting on the seat 12, and right side in FIG. 4), and a fixed portion formed with parts such as a brake housing 25 attached via a cylindrical axle support member 24, which is provided on a periphery of the axle 22L.

The rotational portion of the vehicle braking system 20L includes an annular member 26, or a brake hub, coupled with the wheel hub 23, a plurality of rotational friction plates 27 attached onto the periphery of the annular member 26, and a pair of retaining members, or circlips 28a, 28b, attached to the opposite ends of the annular member 26. The wheel hub 23 is fixed to the periphery of the end of the axle 22L. The wheel hub 23 includes a cylindrical sleeve section 23a located slightly closer to the center of the vehicle than the outermost end of the axle 22L, and a flange section 23b, which is formed in a base of the sleeve section 23a (right end in FIG. 6). The wheel hub 23 is rotationally fixed relative to the axle 22L and, thus, rotates together with the axle 22L.

A periphery of the sleeve section 23 is formed with three steps, among which a diameter of a step in the base side (a portion that corresponds with the end of the axle 22L) is the largest, and the diameter of a step becomes smaller moving closer to the center of the axle 22L (in an axial direction) from the base side. A plurality of spline teeth 23c, which extend in the axial direction of the sleeve section 23a, are formed at regular intervals around a circumference of a central portion of a periphery of the sleeve section 23a. An inclined surface 23d is formed along the circumference at a junction between the central portion and a relatively more inward portion with a smaller radius on the periphery of the sleeve section 23a, such that the diameter of the inclined surface 23d gradually becomes larger moving in a direction from the smaller radius portion of the sleeve section 23a toward the center portion. A fastener, such as nut 29, is fixed to the end of the axle 22L and abuts a rim portion of an outward-facing surface of the fixed section 23b that surrounds a hole through which the axle 22L extends. Accordingly, the wheel hub 23 is prevented from falling off the axle 22L by the nut 29. The rear wheel RL is fixed to the fixed section 23b via a plurality of fasteners, such as a bolt and nut assembly 29a.

On an inner periphery of the annular member 26, a plurality of protrusions 26a are formed at a regular intervals in a circumferential direction and extend in the axial direction. The protrusions 26a are sized and shaped to engage with spline teeth 23c of the sleeve section 23a. The annular member 26 is spline-fitted to the sleeve section 23a by moving the annular member 26 in the axial direction along the periphery of the sleeve section 23a with the protrusions 26a aligned with spaced between the spline teeth 23c. A plurality of spline teeth 26d, which extend in the axial direction, are formed along the circumference at regular intervals on the outer periphery of the annular member 26. The plurality of rotational friction plates 27 are attached to the spline teeth 26d such that the rotational friction plates 27 are fixed for rotation with the annular member 26, but where relative movement in the axial direction with respect to the annular member 26 is possible.

A plurality of projections 27a, which are engageable with the spline teeth 26d of the annular member 26, are formed in the inner periphery of the rotational friction plates 27 at regular intervals around the circumference. The rotational friction plates 27 are fixed for rotation with the annular member 26 by the engagement of the spline teeth 26d with the projections 27a. However, axial movement between the rotational friction plates 27 and the annular member 26. In addition, a groove around the circumference is formed adjacent to each end of the periphery of the annular member 26. Retaining members, such as retaining rings or circlips 28a, 28b, are respectively attached to the grooves. The plurality of rotational friction plates 27 are disposed between these circlips 28a and 28b, and are prevented from falling off, or otherwise becoming disengaged with the annular member 26, by the circlips 28a, 28b.

The fixed portion of the vehicle braking system 20L includes the brake housing 25, a cam ring 31 disposed within the brake housing 25, a plurality of fixed friction plates 32, outer fixed friction plates 33a, 33b respectively disposed on each end of the collection of the plurality of fixed friction plates 32 and the plurality of rotational friction plates 27. The brake housing 25 includes an accommodation section 25a. Openings are formed in a center portion of a base (left-hand segment in FIG. 6) and an outer end, respectively, of the accommodation section 25a. A cover 25b blocks the opening at the outer end of the accommodation section 25a. The plurality of fixed intermediate and outer friction plates 32, 33a and 33b and the rotational friction plates 27 are accommodated within the brake housing 25.

A plurality of engagement grooves 25h, which extend in the axial direction, are formed on an inner periphery of an annular portion 25c at regular intervals around the circumference. The accommodation section 25a includes the annular portion 25c, as one embodiment of a cylindrical engagement part, and a base section 25d fixed to the axle support member 24 such that a rim portion of the base, which surrounds the opening through which the axle support member 24 passes, is closely coupled (preferably sealed) to a periphery of the axle support member 24 via an O-ring 34. A projecting portion, or projection 25e, is formed in the bottom portion of the base section 25d, which extends closer to the center of the axle 22L in an axial direction (and the center of the vehicle 10 in a widthwise or lateral direction) than an inner surface of the rear wheel RL.

Preferably, the projection 25e is, as shown in FIG. 7, formed in an arcuate shape, and one or more cooling fins 25f are formed on the surface of the projection. A space formed inside the projection 25e also projects closer to the center of the axle 22L in the axial direction than the inner surface of the rear wheel RL. A vertical planar section that surrounds the axle 22L is formed on an inner surface of the base surface section 25d, and a plurality of hemispherical holes 25g (FIG. 6) are formed on the planar section at regular intervals in circumferential direction surrounding the axle 22L. A steel ball 35 is placed in each of the hemispherical holes 25g to be rotatable with its center as the rotational center.

The cover 25b is formed as a generally circular plate, and is provided with an opening in its center. The cover 25b is fixed to the accommodation section 25a by plurality of fasteners, such as bolts 36, disposed at regular intervals around the circumference and located towards an outer periphery of the cover 25b. An oil seal 37 is provided between the rim of the opening of the cover 25b and the periphery of the portion of the large radius portion of the sleeve section 23a (i.e., the outermost or right-most illustrated step portion in FIG. 6), and makes a space between the cover 25b and the sleeve section 23a liquid-tight or substantially liquid-tight. Meanwhile, the wheel hub 23 remains rotatable relative to the brake housing 25.

The cam ring 31 is provided within the brake housing 25 in a state where the cam ring 31 faces the inner surface of the base surface section 25e on which the hemispherical holes 25g are formed. Pressing grooves 3 la are formed in portions of the cam ring 31, which face each of the hemispherical holes 25g of the base surface section 25d. The pressing grooves 31 a are elongated in the circumference direction, and include a groove, one end of which is formed in a hemispherical shape and the other end of which narrows.

The hemispherical portions of the pressing grooves 31 a are formed generally symmetrical with the hemispherical holes 25g of the base surface section 25d and each of the steel balls 35 is accommodated between the hemispherical hole 25g and the hemispherical portion of the pressing groove 31a when the base surface section 25d and the cam ring 31 come close to one another. Also, as the narrowed portions of the pressing grooves 31a become narrower, the depth of the grooves 31a gets shallower. When each steel ball 35 is located between the hemispherical hole 25g and the narrowed portion of the pressing groove 31 a, a gap between the base surface section 25d and the cam ring 31 widens. FIG. 6 shows the state where the gap between the base surface section 25d and the cam ring 31 becomes the narrowest.

Although not shown, a rotational shaft 21a of the lever member 21 extends through the base surface section 25d into the inner surface of the base surface section 25d and a rotator (not shown) is coupled with a periphery of a distal end portion of the rotational axis 21a. Then, the cam ring 31 is engaged with the rotator for rotation. Therefore, when the brake wire 18a is pulled forward by the pressing operation of the brake pedal 14, the lever member 21 rotates. The rotational shaft 21a and the rotator rotate along with the rotation of the lever member 21. In addition, because the cam ring 31 rotates by the rotation of the rotator, the cam ring 31 moves in a rotational direction relative to the base surface section 25d. Accordingly, each of the steel balls 35 is respectively moved toward the narrowed side of the pressing grooves 31 a, and the cam ring 31 separates from the base surface section 25d as it rotates.

The intermediate fixed friction plates 32 include a number of individual plates, each of which is disposed between an adjacent pair of the rotational friction plates 27 and includes a ring-shaped main body and plurality of engagement projections 32a that project in a radially outward direction from a periphery of the main body. The engagement projections 32a are formed around the circumference of the main body at regular intervals so as to be engageable with the engagement grooves 25h of the accommodation section 25a. In addition, the outer fixed friction plates 33a, 33b are respectively disposed outside the rotational friction plates 27 which are disposed on each respective end of the plurality of rotational friction plates 27.

The outer fixed friction plates 33a, 33b are formed almost in the same shape as the intermediate fixed friction plates 32; however, the radial dimension of designated engagement projections 33a is larger than that of other engagement projections 33d. Each of the engagement projection 33c is formed with a pin inserting hole. A pin 38 passes through the each of the pin inserting holes. Grooves are respectively formed around the circumference on the periphery of each end of the pins 38. By engaging retaining members, such as circlips 38a, 38b, with the grooves, both of the outer fixed friction plates 33a, 33b are prevented from falling off of, or otherwise becoming disengaged with, the pins 38.

The engagement positions of both of the circlips 38a, 38b with the pins 38 are designed with some clearance so that the spacing between the outer fixed friction plates 33a and 33b can be varied along with the movement of the cam ring 31 in the axial direction. That is, the available space between the circlips 38a, 38b is configured to accommodate the fixed friction plates 32, 33a, 33b in a separated position and in a compressed position. Further, spring members 38c for separating the outer fixed friction plates 33a, 33b from one another are attached in portions between the outer fixed friction plates 33a and 33b on the peripheries of the pins 38. Because the outer fixed friction plates 33a, 33b are separated from one another by the urging force of the spring members 38c when the brake operation is not performed, each of the rotational friction plates 27 and each of the fixed friction plates 32 can be separated from one another in an appropriate condition. Therefore, the rotational force of the axle 22L is transmitted to the rear wheel RL without receiving any (or only a negligible amount of) resistance from the vehicle braking system 20L.

On the other hand, when the brake operation is performed, the outer fixed friction plates 33a, 33b come close to one another against the urging force of the spring members 38c, and both of the outer fixed friction plates 33a, 33b, each of the rotational friction plates 27 and each of the fixed friction plates 32 are frictionally engaged to resist relative rotation therebetween. As a result, the rotation of the axle 22L can be slowed and, if desired, entered into a state where it cannot rotate. An oil seal 37a is provided between the inner periphery at the outer end or tip of the axle support member 24 and the periphery of the small radius portion of the sleeve section 23a, and makes the area between the axle support member 24 and the sleeve section 23a liquid-tight. Meanwhile, the wheel hub 23 is maintained to be rotatable relative to the axle support member 24. A space between the wheel hub 23 and the axle support member 24, that between the axle support member 24 and the brake housing 25, and that between the brake housing 25 and the wheel hub 23 are respectively blocked by the oil seal 37a, the aforementioned 0-ring 34 and the oil seal 37, and an enclosed space is formed in an area surrounded by the wheel hub 23, axle support member 24 and the brake housing 25.

Preferably, a lubricant, such as a lubrication oil O, is provided in the enclosed space. The oil level of the lubrication oil O is, as shown in FIG. 6, preferably is slightly lower than the lower end portion of the small radius portion (i.e., the portion on which the seal 37a is engaged) of the sleeve section 23a when the axle 22L is not rotating. However, once the axle 22L starts rotating, the lubrication oil O is stirred and spattered within the enclosed space. In addition, a screw hole shown in FIG. 7, into which a bolt 41 attached in the central front side of the base surface section 25d of the brake housing 25 is screwed, is connected to the enclosed space formed by the brake housing 25, etc. Therefore, the lubrication oil O can be introduced into the enclosed space from the screw hole by removing the bolt 41.

A screw hole, into which a bolt 42 attached to the bottom of the base surface section 25d of the brake housing 25 is screwed, is also connected to the enclosed space formed by the brake housing 25, etc. Therefore, when the lubrication oil O in the enclosed space deteriorates, the lubrication oil O can be discharged to the outside of the enclosed space through the screw hole by removing the bolt 42. In addition, as shown in FIG. 4 and FIG. 5, a cylindrical air inlet 43, which extends obliquely upward, is formed on the upper side portion of the base surface section 25d, and one end of a hose 43a is attached to the air inlet 43. The enclosed space is maintained in the atmospheric pressure by communicating the enclosed space with the outside via the air inlet 43 and the hose 43a. Meanwhile, the other end of the hose 43a is positioned in an appropriate location on the vehicle 11 so that water, dust and the like do not enter the air inlet 43 via the hose 43a.

The vehicle braking system 20R is provided at a right end of the axle 22R, and is substantially similar to the vehicle braking system 20L. That is, each component constituting the vehicle braking system 20R is the same as that constituting the vehicle braking system 20L, and only the screw holes and the like provided in the brake housing 25 and the like are respectively provided in appropriate positions. Therefore, description of the vehicle braking system 20R is not repeated by assigning the same reference numeral of each component constituting the vehicle braking system 20L to that constituting the vehicle braking system 20R in FIG. 4.

Also, as described above, the axle 22 includes the axle 22L coupled with the rear wheel RL side and the axle 22R coupled with the rear wheel RR side, and the central ends of the axle 22L and the axle 22R are coupled via a differential gear 44. The differential gear 44 (FIG. 3 and FIG. 4) is coupled with an engine (not shown) via each coupling mechanism, and separately transmits drive force of the engine to the axle 22L and the axle 22R. Thereby, the golf cart 10 can turn smoothly even if a gap occurs between the length of the trajectory of the rear wheel RL and that of the rear wheel RR when the golf cart 10 makes a turn.

When the golf cart 10 is driven by activating the engine in this configuration, the wheel hub 23, the annular member 26, and the rotational friction plates 27 rotate along with the axle 22. The lubrication oil O in the enclosed space, which is formed by the brake housing 25 and the like, is spattered within the enclosed space and lubricates each portion in the vehicle braking systems 20L, 20R. In addition, when the golf cart 10 is brought to a stop by operating the brake pedal 14, the outer fixed friction plates 33a, 33b, the rotational friction plates 27 and the fixed friction plates 32 are frictionally engaged, and consequently, the axle 22 is slowed or stopped.

In this case, the outer fixed friction plates 33a, 33b, the rotational friction plates 27, and the intermediate fixed friction plates 32 slide with respect to the brake housing 25 and annular member 26, with which the plates are respectively engaged, and such sliding movement can be accomplished smoothly by the lubricating function of the lubrication oil O. In addition, the temperature of the lubrication oil 0 rises due to the actuation of the vehicle braking systems 20L, 20R. However, because the projection 25e, which is disposed at the bottom portion of the base surface section 25d, projects more toward the center of the axle 22 (and vehicle 10 centerline) than the inner surfaces of the rear wheels RL, RR, the projection 25e is exposed to the air flow and is cooled.

As a result, the lubrication oil O in the brake housing 25 is also cooled. Moreover, because the cooling fin(s) 25f are formed on the surface of the projection 25e, the effectiveness of the cooling of the lubrication oil O is increased. In addition, as the speed of the golf cart O increases, the rotational speed of the rotational friction plates 27 and the like also increases. Consequently, the temperature of the lubrication oil O rises due to agitation and braking by the rotational friction plates 27. However, as the vehicle speed increases, the air flow to the projection 25e is also increased. Therefore, with a preferred arrangement, the lubrication oil O can be appropriately cooled.

As described above, in the vehicle braking systems 20L, 20R according to an embodiment, the projection 25e provided at the bottom end of the brake housing 25 for forming the enclosed space, which retains the lubrication oil O. The projection 25e projects a greater distance toward the interior of the vehicle body 11 than the inner side of the rear wheels RL, RR. Accordingly, such an arrangement significantly reduces or eliminates blockage of the projection 25e of the brake housing 25 by the rear wheels RL, RR. As a result, the projection 25e is exposed to a flow of air while the golf cart 10 is moving, which results in the lubrication oil O within the brake housing 25 being effectively cooled. In addition, because the projections 25e are provided in the bottom portion of the brake housing 25, the lubrication oil O, which tends to drop toward the bottom portion of brake housing 25, is effectively cooled.

Furthermore, because the projection 25e is provided only in a portion of the brake housing 25, the brake housing 25 as a whole is not enlarged. Also, because the cooling fin(s) 25f is provided on the surface of the projection 25e, the cooling effect of the lubrication oil O is further improved, as the exposure of the cooling fin(s) 25f to a flow of air is advantageously increased. Furthermore, because the space formed within the projection 25e is projected a greater distance toward the interior of the vehicle body 11 than the inner side of the rear wheels RL, RR, the cooling efficiency of the lubrication oil O is further improved, and a sufficient volume of the portion, which retains the lubrication oil O, within the brake housing 25 can be provided. Moreover, because the vehicle braking system 20L and the vehicle braking system 20R are formed symmetrically, and also because components constituting the systems 20L and 20R are shared, the cost reduction and simplification of manufacture can be realized.

The present invention is not limited to the embodiments described above and is able to be practiced with various modifications. For example, in the aforementioned embodiment, a golf cart 10 is used as a vehicle; however, a vehicle in the present invention is not limited to the golf cart 10, but any vehicle can be used as far as it includes a vehicle braking system. Furthermore, the configuration of the other components than those described herein of the vehicle braking system according to the present invention can be accordingly changed within the technical scope of the present invention. In addition, although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Additionally, it is contemplated that various aspects and features of the invention described can be practiced separately, combined together, or substituted for one another, and that a variety of combination and subcombinations of the features and aspects can be made and still fall within the scope of the invention. Thus, it is intended that the scope of the present invention herein disclosed should not be limited by the particular disclosed embodiments described above, but should be determined only by a fair reading of the claims.

What is claimed is:

1. A vehicle braking system, comprising:
an axle;
an axle support that rotatably supports the axle;
a wheel hub that is rotationally fixed to an end of the axle;
a wheel supported by the wheel hub;
a plurality of annular rotational friction plates rotationally fixed to the wheel hub, the plurality of rotational friction plates configured for axial movement relative to the wheel hub;
a plurality of annular fixed friction plates, each of which are disposed between a pair of the plurality of rotational friction plates;
a brake housing fixed to the axle support member, wherein a periphery of each of the plurality of fixed friction plates is engaged with an inner periphery of a cylindrical engagement section of the brake housing such that the plurality of fixed friction plates are fixed for rotation with the brake housing and are capable of axial movement relative to the brake housing, wherein rotation of the axle is restrained by pressing the plurality of rotational friction plates and the plurality of fixed friction plates against one another in the axial direction;
wherein the brake housing and the wheel hub cooperate to form a space for accommodating the plurality of rotational friction plates and the plurality of fixed friction plates, lubrication oil is contained in the space for lubricating the plurality of rotational friction plates and the plurality of fixed friction plates; and
wherein a portion of the brake housing that is located below the axle projects further toward a center of the axle in a direction along a longitudinal axis of the axle than an innermost surface of the wheel.

2. The vehicle braking system of claim 1, wherein at least one cooling fin is provided on the portion of the brake housing that projects further toward the center of the axle than of the innermost surface of the wheel.

3. The vehicle braking system of claim 2, wherein a portion of the space within the brake housing that is located below the axle projects further toward the center of the axle than an innermost surface of the wheel.

4. The vehicle braking system of claim 1, wherein a portion of the space within the brake housing that is located below the axle projects further toward the center of the axle than an innermost surface of the wheel.

5. The vehicle braking system of claim 1, wherein the portion of the brake housing that projects further toward the center of the axle than of the innermost surface of the wheel is generally arcuate in shape.

6. The vehicle braking system of claim 5, wherein the arcuate shape is curved in an upward direction at each end relative to a center of the arcuate shape.

7. The vehicle braking system of claim 1, further comprising an opening for permitting the lubrication oil to be discharged from the space, wherein the opening is defined by the portion of the brake housing that projects further toward the center of the axle than of the innermost surface of the wheel.

8. The vehicle braking system of claim 7, wherein an axis of the opening is generally aligned with an axis of the axle.

9. A vehicle braking system, comprising:
an axle;
an axle support that rotatably supports the axle;
a wheel hub that is rotationally fixed to an end of the axle;
a wheel supported by the wheel hub;
a plurality of first friction plates rotationally fixed relative to the wheel hub, the plurality of first friction plates configured for axial movement relative to the wheel hub;
a plurality of second friction plates, each of which are disposed between a pair of the plurality of first friction plates;
a brake housing fixed to the axle support member, wherein each of the plurality of second friction plates is rotationally fixed relative to the brake housing and is capable of axial movement relative to the brake housing, wherein rotation of the axle is restrained when the plurality of first friction plates and the plurality of second friction plates are forced into frictional engagement with one another in the axial direction;
wherein the brake housing and the wheel hub cooperate to form an interior space for accommodating the plurality of first and second friction plates, a lubricant is contained in the space for lubricating the plurality of first and second friction plates; and
wherein the brake housing defines a projecting portion that is located below the axle and projects further inward than an innermost surface of the wheel relative to a longitudinal axis of the axle.

10. The vehicle braking system of claim 9, wherein at least one cooling fin is provided on the projecting portion of the brake housing.

11. The vehicle braking system of claim 9, wherein a portion of the interior space projects further inward than an innermost surface of the wheel.

12. The vehicle braking system of claim 9, wherein the projecting portion of the brake housing is generally arcuate in shape.

13. The vehicle braking system of claim 12, wherein the arcuate shape is curved in an upward direction at each end relative to a center of the arcuate shape.

14. The vehicle braking system of claim 9, further comprising an opening for permitting the lubrication oil to be discharged from the interior space, wherein the opening is defined by the projection portion of the brake housing.

15. The vehicle braking system of claim 14, wherein an axis of the opening is generally aligned with the longitudinal axis of the axle.
